(19) United States
(12) Patent Application Publication
(10) Pub. No.: US 2012/0107780 A1
(43) Pub. Date: May 3, 2012

(54) INSPECTION APPARATUS AND INSPECTION METHOD

(75) Inventor: Ryoji MOTOKI, Yokohama-shi (JP)

(73) Assignee: OLYMPUS CORPORATION, Tokyo (JP)

(21) Appl. No.: 12/913,953

(22) Filed: Oct. 28, 2010

(51) Int. Cl. G09B 19/00

(52) U.S. Cl. 434/219

(57) ABSTRACT

An inspection apparatus includes: a display, a first display control section which displays, on the display, instructions for carrying out a plurality of inspection steps with the inspection apparatus, an evaluation section which performs an evaluation of a result of one of the inspection steps, a second display control section which displays, on the display, additional instructions for carrying out at least one additional inspection step; and, a control section which controls the second display control section to display the additional instructions in response to the evaluation section determining that said one of the inspection steps has not passed the evaluation.

### BACKGROUND OF THE INVENTION

1. Field of the Invention

The present invention relates to an inspection apparatus and an inspection method that are used in inspections which are based on an image of a subject.

2. Description of Related Art

In manufacturing processes for manufacturing various types of industrial products such as boilers, turbines, engines, pipes, and semiconductor components, inspections are performed in order to verify whether or not any defects are present in the product. In Unites States Patent Application Publication No. 2007/0225931, a technology is disclosed in which a procedure for a plurality of inspection steps is displayed on a monitor during an inspection. In this technology, when each inspection step is completed, a + sign is displayed next to numbers which show the sequence of the inspection steps in order to enable completed inspection steps to be distinguished from uncompleted inspection steps.

### SUMMARY OF THE INVENTION

An inspection apparatus includes: a display, a first display control section which displays, on the display, instructions for carrying out a plurality of inspection steps with the inspection apparatus, an evaluation section which performs an evaluation of a result of one of the inspection steps, a second display control section which displays, on the display, additional instructions for carrying out at least one additional inspection step; and, a control section which controls the second display control section to display the additional instructions in response to the evaluation section determining that said one of the inspection steps has not passed the evaluation.

### BRIEF DESCRIPTION OF THE DRAWINGS

FIG. 1 is a perspective view showing the overall structure of an endoscope apparatus according to an embodiment of the present invention.

FIG. 2 is a block diagram showing the internal structure of the endoscope apparatus according to the embodiment of the present invention.

FIG. 3 is a block diagram showing the function structure of a CPU provided in the endoscope apparatus according to the embodiment of the present invention.

FIG. 4 is a flowchart showing an operating procedure of the endoscope apparatus according to a first operation example of the embodiment of the present invention.

FIG. 5 is a view showing a screen in the first operation example.

FIG. 6 is a view showing a screen in the first operation example.

FIG. 7 is a view showing a screen in the first operation example.

FIG. 8 is a view showing a modified version of a screen in the first operation example.

FIG. 9 is a view showing a modified version of a screen in the first operation example.

FIG. 10 is a flowchart showing an operating procedure of the endoscope apparatus according to a second operation example of the embodiment of the present invention.

FIG. 11 is a view showing a screen in the second operation example.

FIG. 12 is a view showing a screen in the second operation example.

FIG. 13 is a flowchart showing an operating procedure of the endoscope apparatus according to a third operation example of the embodiment of the present invention.

FIG. 14 is a view showing a screen in the third operation example.

FIG. 15 is a view showing a screen in the third operation example.

FIG. 16 is a view illustrating a method used to determine three-dimensional coordinates of a measurement point using stereo measurement.

### DETAILED DESCRIPTION OF THE INVENTION

Embodiments of the present invention will be described with reference made to the drawings. Hereinafter, an endoscope apparatus having a measurement function for measuring the size of a subject by using an image of the subject is described as an example of an inspection apparatus. If an inspection procedure including a plurality of inspection steps is fixed, when the inspection result of the middle inspection step (for example) is wrong, it is not possible to perform an inspection in a way other than the pre-fixed inspection procedure, even if the inspector wants to alter the inspection procedure. Therefore, the inspector is inconvenienced. In an inspection apparatus of the present embodiment, the inspection procedure is not fixed and is altered based on an inspection result of one or more of the inspection steps. Therefore, it is possible to efficiently perform the inspection.

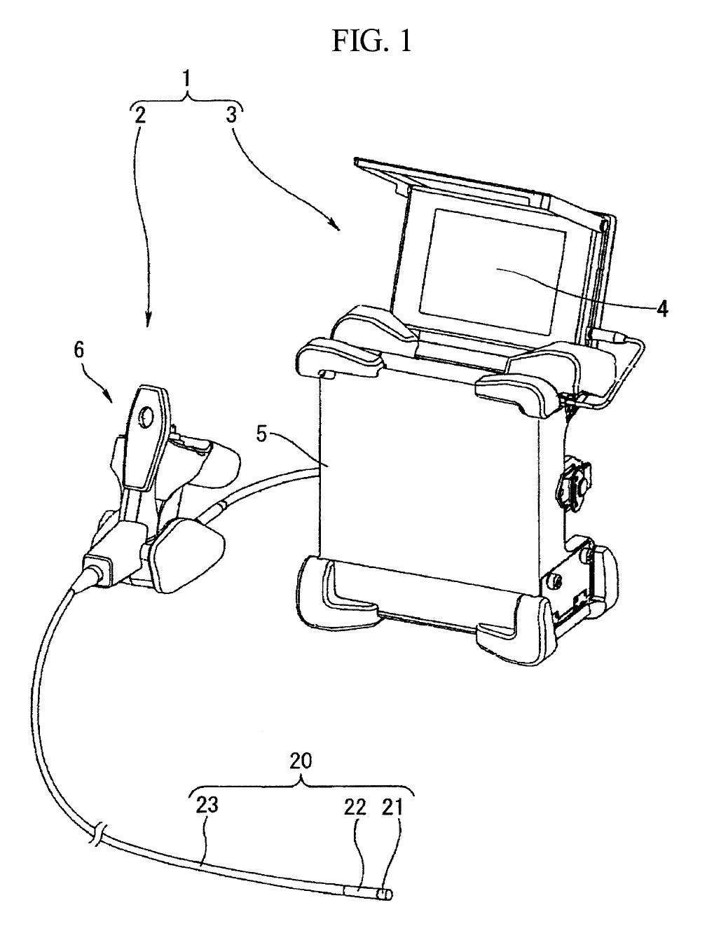

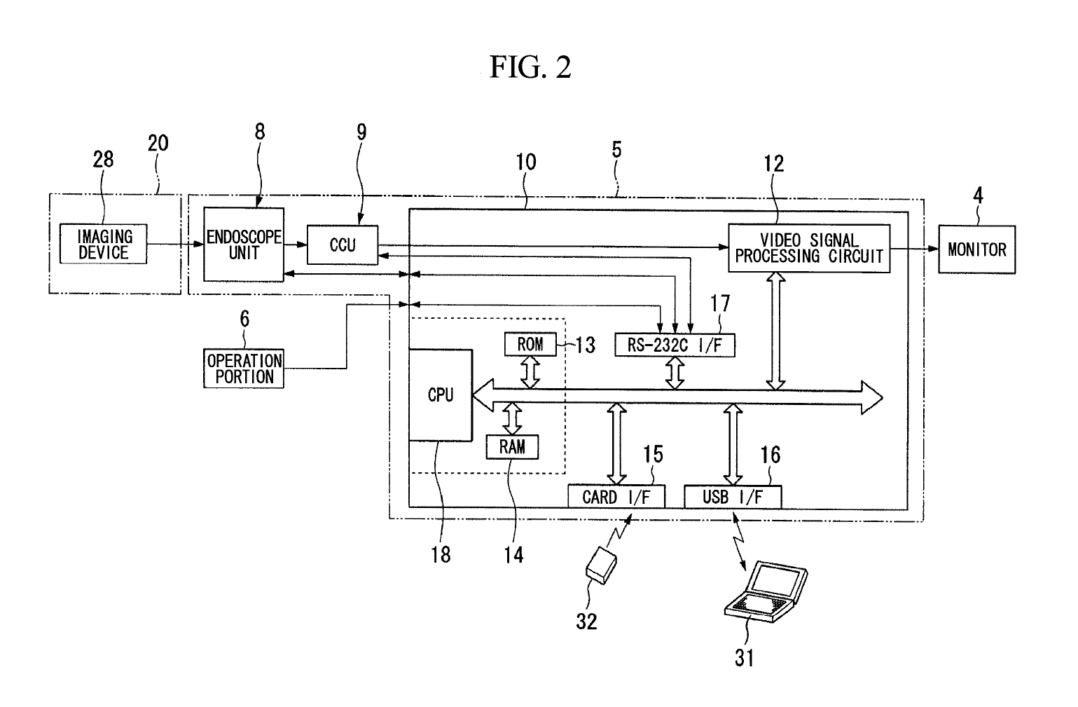

FIG. 1 shows the structure of an endoscope apparatus. As is shown in FIG. 1, an endoscope apparatus 1 is provided with an endoscope 2, and an apparatus main body 3 which is connected to the endoscope 2. The endoscope 2 is provided with a narrow, elongated insertion portion 20, and an operation portion 6 (i.e., an input device) that is used to perform operations required in executing various kinds of operation controls of the entire apparatus. The apparatus main body 3 is provided with a monitor 4 (a liquid crystal monitor) which is a display device that displays images of a subject which have been acquired by the endoscope 2 and also displays operation control contents (for example, processing menus) and the like, and with a housing 5 which internally houses a control unit 10 (see FIG. 2).

The insertion portion 20 is formed by linking together in the following order from the distal end side a rigid distal end portion 21, a bent portion 22 capable of being bent, for example, in the vertical and horizontal directions, and a flexible tube portion 23 which is formed from a pliable material. Various kinds of optical adapters, such as a stereo optical adapter having two observation fields of view or a normal observation optical adapter having one observation field of view, can be attached to the distal end portion 21 in a freely detachable manner. In the present embodiment, at the time of measurement, a left image and a right image which are a pair of left and right subject images are acquired via a stereo optical adaptor which is capable of forming two subject images relating to the same subject.

As is shown in FIG. 2, an endoscope unit 8, a CCU 9 (i.e., a camera control unit), and the control unit 10 are provided inside the housing 5. A proximal end portion of the insertion portion 20 is connected to the endoscope unit 8. The endoscope unit 8 includes a light source driving device that drives a light source (for example, an LED 29) that is built in the distal end portion 21, and a bending device that bends the bent portion 22 which constitutes part of the insertion portion 20.

An imaging device 28 and the LED are built in the distal end portion 21. The imaging device 28 photoelectrically converts a subject image formed via the optical adaptor to create an image signal. The image signal output from the imaging device 28 is input to the CCU 9. The image signal is converted into a video signal (i.e., image data) such as an NTSC signal in the CCU 9, and is then supplied to the control unit 10. The LED generates illumination light which is irradiated onto a subject. In the present embodiment, the LED is built in the distal end portion 21, however, the LED may be placed inside the housing 5, and the illumination light generated by the LED may be guided to the distal end portion 21 via an optical fiber. Illumination devices other than the LED may be used as a light source.

A video signal processing circuit 12 to which the video signal is input, a ROM 13, a RAM 14, a card I/F 15 (card interface), a USB I/F 16 (USB interface), an RS-232C I/F 17 (RS-232C interface), and a CPU 18 that executes various functions based on a main program stored in ROM 13 and that performs operation controls are provided in the control unit 10.

The CCU 9 and the endoscope unit 8 are connected to the RS-232C I/F 17. In addition, the operation portion 6 which performs control and operation instructions of the CCU 9, endoscope unit 8, and the like is connected to the RS-232C I/F 17. When a user operates the operation portion 6, a communication required for controlling the operations of the CCU 9 and the endoscope unit 8 is performed based on the operation contents.

The USB I/F 16 is an interface that electrically connects the control unit 10 and a personal computer 31 to each other. By connecting the control unit 10 to the personal computer 31 through the USB I/F 16, various kinds of instruction and controls, such as an instruction to display an endoscope image and image processing at the time of measurement, can be performed at the side of the personal computer 31. In addition, input and output of control information, data, and the like, which are required for various processing, between the control unit 10 and the personal computer 31 can be performed.

A memory card 32 can be freely attached to or detached from the card I/F 15. By mounting the memory card 32 in the card I/F 15, it is possible to take data, such as control processing information or image information, stored in the memory card 32 into the control unit 10, or to record data, such as the control processing information or the image information, in the memory card 32, in accordance with control of the CPU 18.

In order to display a synthesized image obtained by synthesizing an endoscope image based on the video signal supplied from the CCU 9 with a graphic image such as an operation menu, the video signal processing circuit 12 performs processing for synthesizing a graphic image signal created by the control of the CPU 18 with the video signal from the CCU 9, processing required for displaying the synthesized image on the screen of the monitor 4, and the like, and supplies a display signal to the monitor 4. In addition, the video signal processing circuit 12 may also perform processing for simply displaying an endoscope image or an operation menu image, independently. Accordingly, the endoscope image, the operation menu image, the synthesized image obtained by synthesizing the endoscope image with the operation menu image, and the like, are displayed on the screen of the monitor 4.

The CPU 18 controls the overall operations of the endoscope apparatus 1 by executing a program stored in the ROM 13 in order to control various circuit portions to perform desired processing. The CPU 18 uses the RAM 14 as a working area for temporarily storing data.

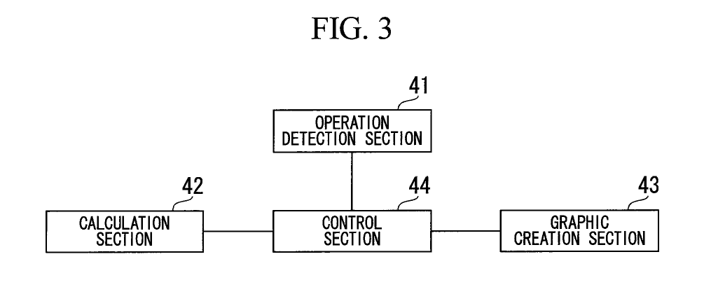

FIG. 3 shows the function structure of the CPU 18. An operation detection section 41 detects the type of operation of the operation portion 6 input by a user. A calculation section 42 performs processing to calculate three-dimensional coordinates based on the principle of triangulation, and also performs processing to calculate the length, the surface area, and the like of the subject. A graphic creation section 43 creates a graphic image signal that is used to display various types of information which are displayed using characters, numbers or the like on a display screen, and to display cursor icons and the like. A control section 44 controls the allocation of processing to each one of the operation detection section 41, the calculation section 42, and the graphic creation section 43, and also controls the overall operations of the endoscope apparatus 1.

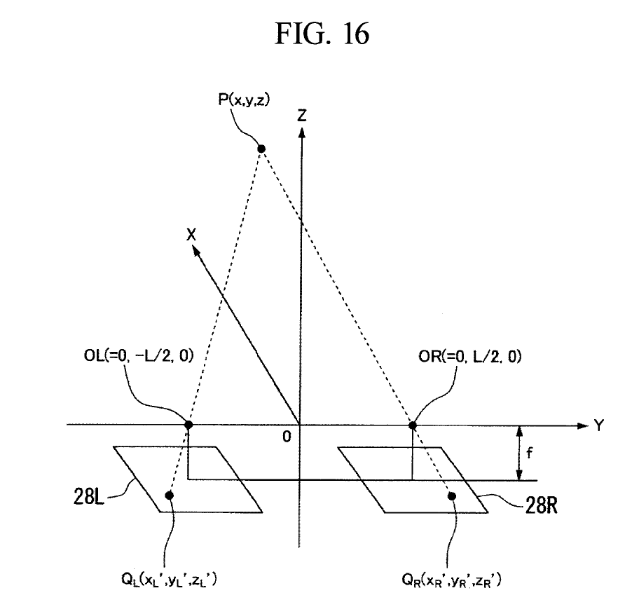

Next, the basic principle of measurement in the present embodiment (i.e., stereo measurement) will be described. FIG. 16 shows the positional relationship between two left and right images on the three-dimensional spatial coordinate system with x, y, and z axes. FIG. 16 shows a state where a point P, which is an object for measuring a distance (object distance) to the subject, is imaged on a right imaging surface 28R and a left imaging surface 28L of the imaging device 28. In FIG. 16, it is assumed that points OR and OL are main points of the optical system, a distance f is a focal length, points Q_{R} and Q_{L} are image locations of the point P, and a distance L is a distance between the point OR and the point OL.

In FIG. 16, expression (1) is obtained from the straight line Q_{R}-OR.

x/x_{R}={y−(L/2)}/{y_{R}−(L/2)}=z/(−^{f}) (1)

In addition, expression (2) is obtained from the straight line Q_{L}-OL.

x/x_{L}={y+(L/2)}/{y_{L}+(L/2)}=z/(−^{f}) (2)

The three-dimensional coordinates of the point P are obtained by solving these expressions for x, y, and z. As a result, the distance (object distance) from the point OR or the point OL to the subject is calculated as the z-coordinate of the point P. In addition, the three-dimensional length and the three-dimensional area can be obtained by calculating the three-dimensional coordinates of the point P for a plurality of measurement points and making various calculations using the three-dimensional coordinates.

Next, operations performed during an inspection will be described. Hereinafter, three operation examples will be given.

### First Operation Example

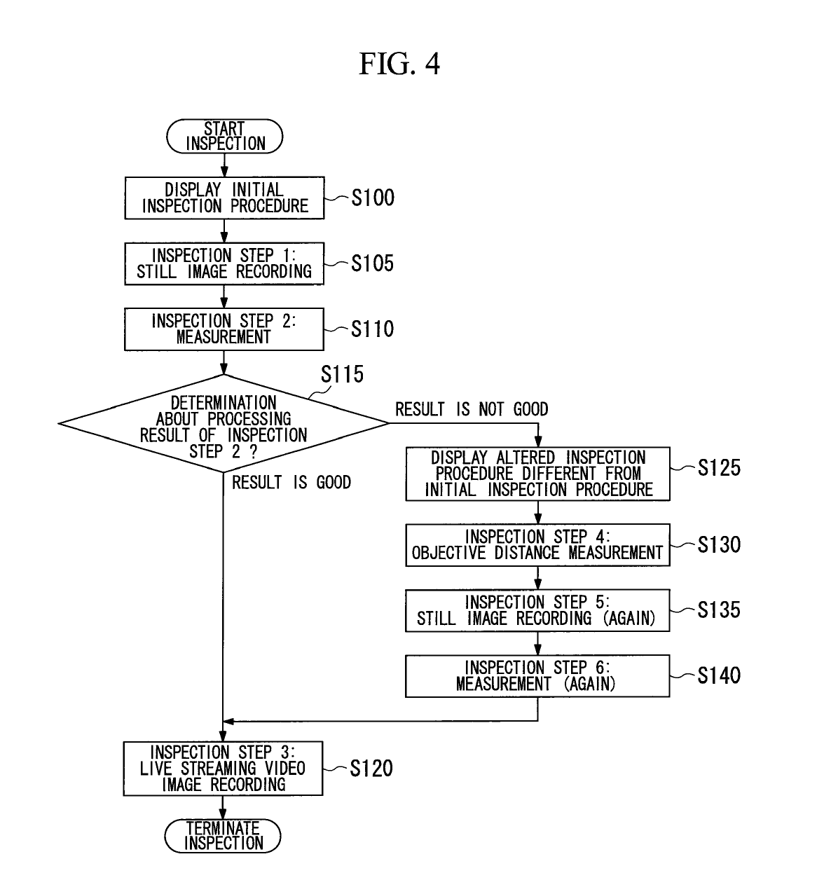

FIG. 4 shows a procedure of a first operation example. When an inspector turns on the power of the endoscope apparatus 1, the operations of each section start, and the monitor 4 displays a subject image captured by the imaging device 28. While viewing the image displayed on the monitor 4, the inspector inserts the insertion portion 20 into the interior of the subject to be inspected, and moves the distal end portion 21 to an inspection position. During this time, an objective distance which provides an indication of the measurement accuracy may be measured and displayed on the monitor 4. In the example given below, a stereo optical adaptor for the stereo measurement is attached to the distal end portion 21.

(Step S100)

When an inspector selects an inspection method and instructs start of the inspection by operating the operation portion 6, the operation detection section 41 detects the start inspection instruction, and notifies the control section 44 of the start inspection instruction. The control section 44 instructs the graphic creation section 43 to create a graphic image signal for displaying an initial inspection procedure. The graphic creation section 43 creates a graphic image signal and outputs it to the video signal processing circuit 12. The video signal processing circuit 12 outputs to the monitor 4 a display signal formed by synthesizing the graphic image signal with the video signal from the CCU 9. Based on this display signal, the monitor 4 displays the subject images captured by the imaging device 28 as well as the initial inspection procedure. The subject images captured by the imaging device 28 are updated at a constant frequency.

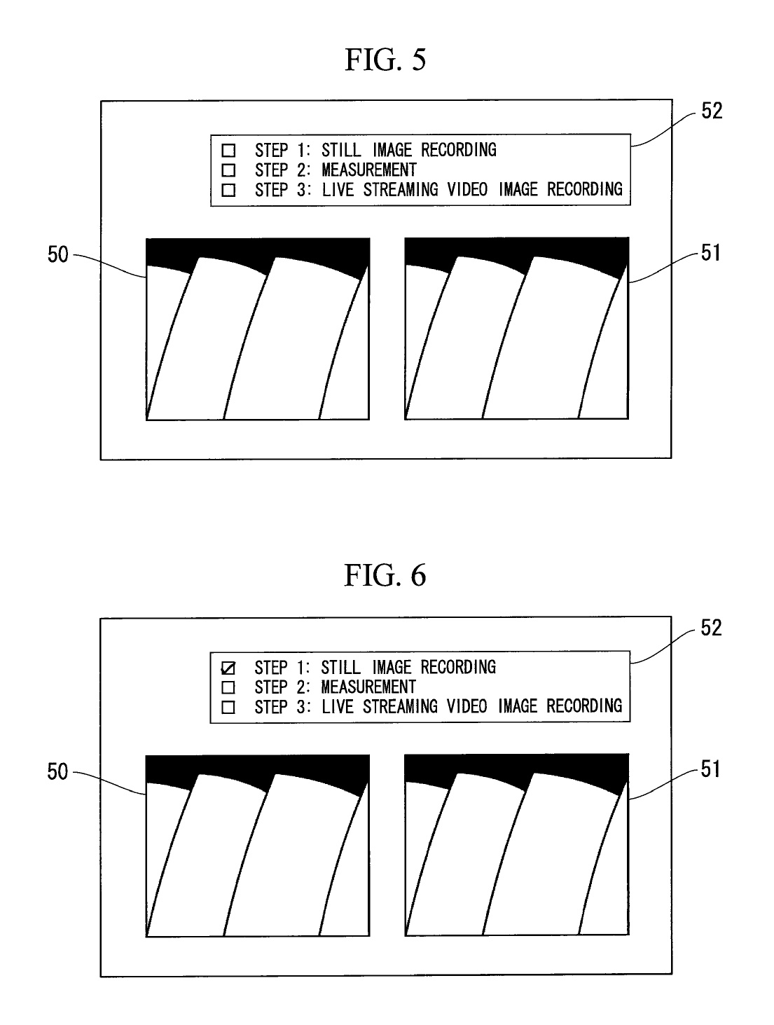

FIG. 5 shows the screen of the monitor 4 when the initial inspection procedure is displayed. A left image 50 and a right image 51 are left and right subject images captured by the imaging device 28 via the stereo optical adaptor. A region 52 is a region where the inspection procedure is displayed. The initial inspection procedure includes three inspection steps, namely, still image recording, measurement, and live streaming video image recording. The still image recording and the live streaming video image recording are inspection steps in which data that is used to subsequently confirm the subject is recorded. The measurement is an inspection step in which the size of the subject is measured. When each inspection step is completed, a check is added in a square mark in front of the description of that inspection step. The inspector is able to ascertain the state of progress of the inspection by confirming whether or not this check is present. In FIG. 5, menus and the like are not shown.

(Step S105)

After the initial inspection procedure is displayed, the processing of the first inspection step, namely, of the still image recording is performed. In the still image recording, the inspector operates the operation portion 6 and inputs an instruction to freeze the video image. The operation detection section 41 detects the instruction to freeze the video image and notifies the control section 44 of the instruction to freeze the video image. The video image displayed on the monitor 4 is then frozen by the control of the control section 44. When the inspector operates the operation portion 6 and inputs an instruction to record the still image, the operation detection section 41 detects the instruction to record the still image and notifies the control section 44 of the instruction to record the still image. The control section 44 then records as still image data in the memory card 32 the image data of one frame which has been processed by the video signal processing circuit 12.

(Step S110)

When the still image data has been recorded in the memory card 32, a check is added in a square mark in front of the description of the still image recording included in the initial inspection procedure displayed on the monitor 4, by the control of the control section 44 (see FIG. 6). Subsequently, the processing of the next inspection step, namely, of the measurement is performed. In the measurement, the image data of one frame which has been processed by the video signal processing circuit 12 is used. The inspector operates the operation portion 6 and inputs measurement points which indicate the measurement positions on the left image displayed on the monitor 4. For example, in the point-to-point distance measurement, two measurement points are input. The positions of the measurement points are specified using a cursor displayed on the monitor 4.

The operation detection section 41 detects the type of operation of the operation portion 6. The calculation section 42 calculates two-dimensional coordinates (i.e., image coordinates) of the measurement point based on the type of operation, and also calculates the two-dimensional coordinates of a point on the right image that corresponds to the calculated two-dimensional coordinates of the measurement point by pattern matching of the left and right images. The calculation section 42 calculates spatial three-dimensional coordinates from the two-dimensional coordinates of the measurement point on the left image and the point on the right image that corresponds to the measurement point. The calculation section 42 then calculates the size of the subject to be inspected from the three-dimensional coordinates of a plurality of points. The calculated size of the subject to be inspected is displayed on the monitor 4 as a measurement result.

(Step S115)

When the measurement result has been displayed on the monitor 4, a check is added in a square mark in front of the description of the measurement included in the initial inspection procedure displayed on the monitor 4, by the control of the control section 44. Subsequently, the control section 44 makes a determination about (evaluates) the processing result of the measurement. With this determination, the measurement accuracy which is one of the measurement conditions is determined Examples of the determination (evaluation) method of the processing result of the measurement include: [1] a method using a contrast value of a texture; [2] a method using the object distance to the subject to be inspected; and [3] a method using a normalized cross-correlation coefficient.

The contrast value of the texture is calculated as follows. An image region for calculating the contrast value of the texture is assumed to be a region of 11×11 pixels which is the size of a pattern area on which the pattern matching has been performed. A contrast value C(d, θ) of the texture is generally calculated as follows. A co-occurrence matrix D(a, b; d, θ) is expressed as an intensity pair (a, b) of a pixel pair [(x, y), (u, v)] which is in the specific relative positional relationship (d, θ) (d is a distance and θ is an angle). In this case, f(x, y)=a and f(u, v)=b are assumed. When ‘L’ kinds of pixels of 0 to L−1 exist, D(a, b; d, θ) becomes a matrix of L×L. A value obtained by normalizing D such that the sum of all elements becomes 1 is expressed as the following expression (3). In this case, N_{L}={0, 1, 2, . . . , L−1}.

$$k ( a , b ; d , θ ) = \frac{D ( a , b ; d , θ )}{{\sum }_{a ∈ {N}_{L}}^{ } {\sum }_{b ∈ {N}_{L}}^{ } d ( a , b ; d , θ )} \qquad ( 3 )$$

The contrast value of the texture is expressed as the following expression (4).

$$C ( d , θ ) = {\sum }_{a ∈ {N}_{L}}^{ } {\sum }_{b ∈ {N}_{L}}^{ } \{ {( a - b )}^{2} \times k ( a , b ; d , θ ) \} \qquad ( 4 )$$

The object distance to the subject to be inspected is calculated by the method which is described above with reference made to FIG. 16.

The normalized cross-correlation coefficient is calculated as follows. The calculation section 42 sets a template range on the left image, sets a search range on the right image, and performs pattern matching between an image of the template range and an image of a pattern area within the search range. In this pattern matching, detection of a corresponding point using normalized cross correlation is performed to set coordinates (X, Y) with the largest normalized cross-correlation coefficient (−1˜+1) as the corresponding point. The pattern matching is repeatedly performed while alternating the size of the pattern area and moving the pattern area within the search range.

For a normalized cross-correlation function M(u, v) used in the pattern matching, the following expression is generally used. That is, assuming that t(x, y) is a pixel value of a pixel (x, y) of the template image, g(x, y) is a pixel value of a pixel (x, y) of the pattern area image, t′ is an average luminance of the template image, and g′ is an average luminance of the pattern area image, the following expression (5) is applied. Here, ΣΣₛ means the sum of pixels. The largest value obtained by pattern matching is used for the determination of the measurement accuracy.

M(u, v)={ΣΣₛ(g(x+u, y+v)−g′)(t(x, y)−t′)}/{ΣΣₛ(g(x+u, y+v)−g′)²×ΣΣₛ(t(x, y)−t′)²}^{1/2} (5)

The determination based on the contrast value of the texture is made in the following manner. The control section 44 determines that the processing result is good (i.e., passes the evaluation, or in other words the measurement accuracy is satisfactory) when the difference in the contrast value of the texture, obtained by the calculation section 42, between the left and right images is less than a predetermined value. The control section 44 determines that the processing result is not good (i.e., fails the evaluation, or in other words the measurement accuracy is not satisfactory) when the difference in the contrast value of the texture, obtained by the calculation section 42, between the left and right images is equal to or more than the predetermined value.

The determination based on the object distance to the subject to be inspected is made in the following manner. The control section 44 determines that the processing result is good (i.e., passes the evaluation, or in other words the measurement accuracy is satisfactory) when a value of the object distance calculated by the calculation section 42 is equal to or more than 0. The control section 44 determines that the processing result is not good (i.e., fails the evaluation, or in other words the measurement accuracy is not satisfactory) when a value of the object distance calculated by the calculation section 42 is less than 0.

The determination based on the normalized cross-correlation coefficient is made in the following manner. The control section 44 determines that the processing result is good (i.e., passes the evaluation, or in other words the measurement accuracy is satisfactory) when a value of the normalized cross-correlation coefficient calculated by the calculation section 42 is equal to or more than a predetermined value. The control section 44 determines that the processing result is not good (i.e., fails the evaluation, or in other words the measurement accuracy is not satisfactory) when a value of the normalized cross-correlation coefficient calculated by the calculation section 42 is less than the predetermined value.

Alternatively, the determination may be made based on an evaluation value obtained by multiplying weighting coefficients by the contrast value of the texture, the object distance to the subject to be inspected, and the normalized cross-correlation coefficient, respectively, and then adding the multiplied values.

(Step S120)

When the processing result is determined as good in step S115, the processing of the next inspection step, namely, of the live streaming video image recording is performed. In the live streaming video image recording, the inspector operates the operation portion 6 and inputs an instruction to start the live streaming video image recording. The operation detection section 41 detects the instruction to start the live streaming video image recording and notifies the control section 44 of the instruction to start the live streaming video image recording. The control section 44 then records as live streaming video image data in the memory card 32 the image data of each frame which has been processed by the video signal processing circuit 12. Subsequently, the inspector operates the operation portion 6 and inputs an instruction to terminate the live streaming video image recording. The operation detection section 41 detects the instruction to terminate the live streaming video image recording and notifies the control section 44 of the instruction to terminate the live streaming video image recording. The control section 44 then terminates the live streaming video image recording. When the live streaming video image recording terminates, the inspection also terminates.

(Step S125)

When the processing result is determined as not good in step S115, the control section 44 instructs the graphic creation section 43 to create a graphic image signal for displaying an altered inspection procedure which is different from the initial inspection procedure. The graphic creating section 43 creates a graphic image signal and outputs it to the video signal processing circuit 12. The video signal processing circuit 12 outputs to the monitor 4 a display signal formed by synthesizing the graphic image signal with the video signal from the CCU 9. Based on this display signal, the monitor 4 displays the subject images captured by the imaging device 28 as well as the altered inspection procedure.

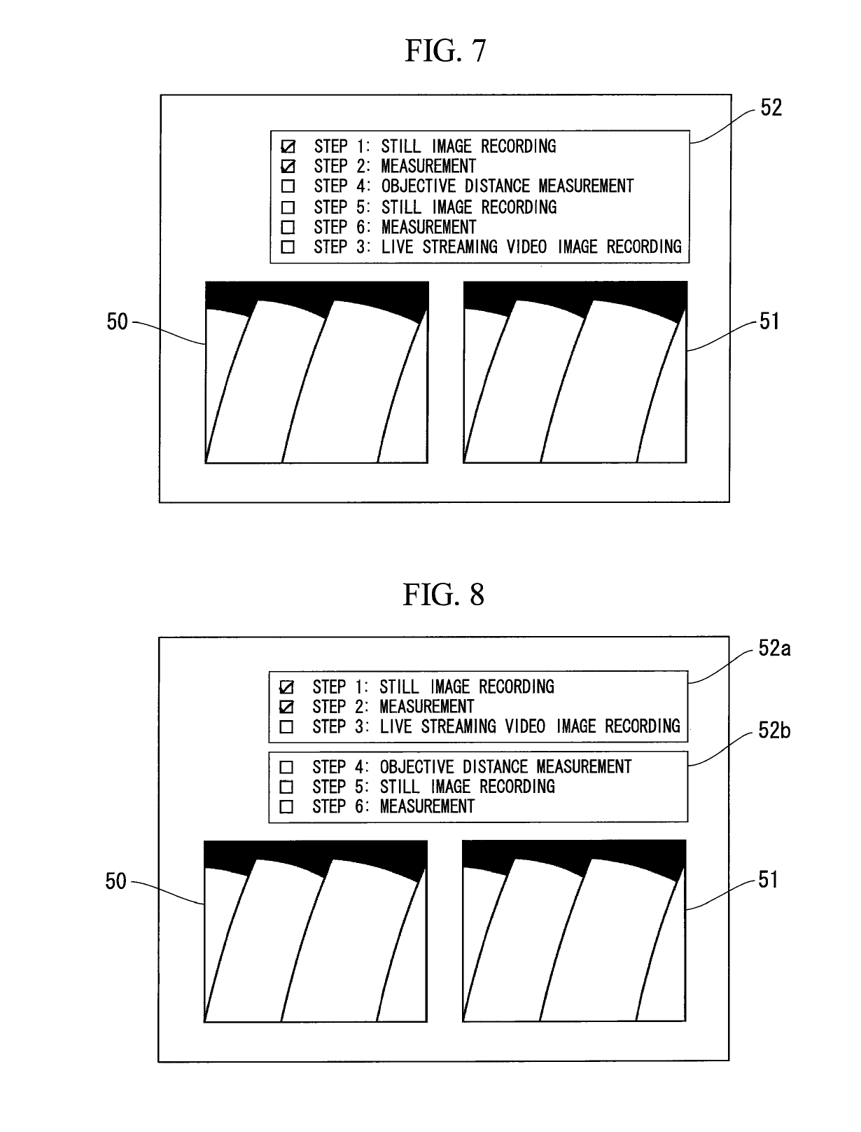

FIG. 7 shows the screen of the monitor 4 when the altered inspection procedure is displayed. The altered inspection procedure is displayed in the region 52 where the inspection procedure is displayed. The altered inspection procedure includes three newly added inspection steps, namely, objective distance measurement, still image recording, and measurement, in addition to the three inspection steps of the still image recording, the measurement, and the live streaming video image recording which are included in the initial inspection procedure. As is shown in FIG. 7, the three newly added inspection steps of the objective distance measurement, the still image recording, and the measurement are inserted in the middle of the initial inspection procedure between the inspection step of the measurement and the inspection step of the live streaming video image recording. In FIG. 7, numbers 1 through 3 are given to the three inspection steps included in the initial inspection procedure and numbers 4 through 6 are given to the three newly added inspection steps. However, numbers 1 through 6 may be given to these six inspection steps in the order corresponding to the altered inspection steps.

(Step S130)

After the altered inspection procedure is displayed, the processing of the first newly added inspection step, namely, of the objective distance measurement is performed. In the objective distance measurement, the subject images captured by the imaging device 28 are updated at a constant frequency. The calculation section 42 calculates two-dimensional coordinates of a reference point (for example, a point at the position indicated by the cursor) on the left image, and also calculates two-dimensional coordinates of a point on the right image that corresponds to the calculated two-dimensional coordinates of the reference point by pattern matching. The calculation section 42 calculates three-dimensional coordinates from the two-dimensional coordinates of the reference point on the left image and the point on the right image that corresponds to the reference point. The z-coordinate value of the three-dimensional coordinates is the objective distance. The calculated objective distance is displayed on the monitor 4. In this inspection step, it is desirable for the inspector to adjust the position of the distal end portion 21 so that the objective distance becomes a distance suitable for measurement. As a result, an inspection condition is altered.

(Step S135)

After the objective distance is displayed, a check is added in a square mark in front of the description of the objective distance measurement included in the altered inspection procedure displayed on the monitor 4, by the control of the control section 44. Subsequently, the processing of the next inspection step, namely, of the still image recording is performed. In the still image recording, processing which is the same as the processing of step S105 is performed.

(Step S140)

When the still image data has been recorded in the memory card 32, a check is added in a square mark in front of the description of the still image recording included in the altered inspection procedure displayed on the monitor 4, by the control of the control section 44. Subsequently, the processing of the next inspection step, namely, of the measurement is performed. In the measurement, processing which is the same as the processing of step S110 is performed.

(Step S120)

When the measurement result has been displayed on the monitor 4, a check is added in a square mark in front of the description of the measurement included in the altered inspection procedure displayed on the monitor 4, by the control of the control section 44. Subsequently, the processing of the next inspection step, namely, of the live streaming video image recording is performed. The processing of the live streaming video image recording is as described above. When the live streaming video image recording terminates, the inspection terminates.

As is described above, when the processing result of an inspection step (the measurement step in the example described above) is determined as not good, the inspection procedure is altered. If the inspection procedure is fixed, it is not possible to re-execute already completed inspection steps until the last inspection step, namely, the live streaming video image recording is completed and then the inspection is started all over again. In the above-described example, when the processing result of the measurement is determined as not good, it is possible to re-execute the still image recording and the measurement before the live streaming video image recording is started. Therefore, it is possible to efficiently perform the inspection.

In each of the above described inspection steps, control of prohibiting operations of other inspection steps may be performed until an operation which is assumed as an operation of that inspection step has been completed. For example, in the still image recording, operations such as measurement and live streaming video image recording may be prohibited until an instruction to record the still image has been input. In the measurement, operations such as still image recording and live streaming video image recording may be prohibited until the necessary number of measurement points required for the measurement has been input. In the live streaming video image recording, operations such as still image recording and measurement may be prohibited until an instruction to terminate the live streaming video image recording has been input.

Further, the altered inspection procedure may be displayed as follows. For example, in FIG. 7, the three newly added inspection steps included in the altered inspection procedure may be displayed in a different display form from the three inspection steps included in the initial inspection procedure. Examples of the different display form include differences in the color of the characters, differences in the size of the characters, differences in the character font, differences in the background color of the characters, or the presence or otherwise of a mark. Further, the examples of the different display form include the following state where inspection steps are displayed in different regions.

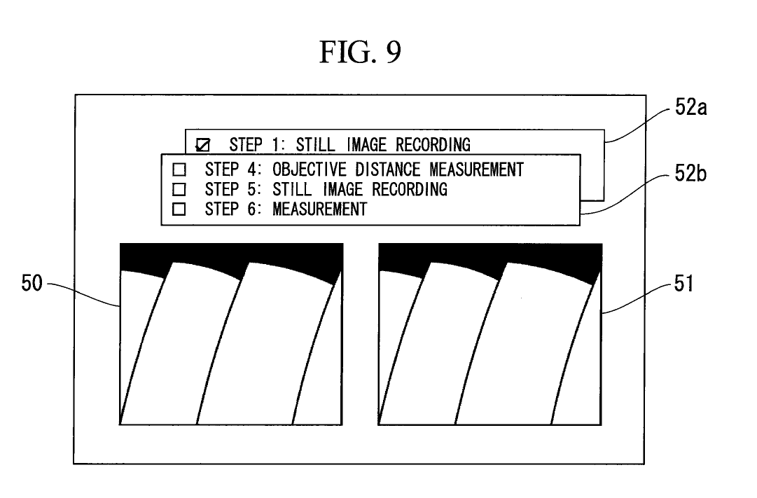

FIG. 8 shows an example in which the three inspection steps included in the initial inspection procedure and the three newly added inspection steps are displayed in different regions. The initial inspection procedure is displayed in a region 52a, while the altered inspection procedure is displayed in a region 52b. The region 52a and the region 52b may be overlapped. FIG. 9 shows an example in which the region 52a and the region 52b are overlapped. For example, the regions 52a and 52b may be displayed such that the region 52a is superimposed on the region 52b when an inspection step included in the initial inspection procedure is being executed, and such that the region 52b is superimposed on the region 52a when an inspection step included in the altered inspection procedure is being executed. Alternatively, the region 52a may be displayed and the region 52b may be hidden when an inspection step included in the initial inspection procedure is being executed, the region 52b may be displayed and the region 52a may be hidden when an inspection step included in the altered inspection procedure is being executed. Alternatively, the apparatus may be configured such that a state in which the region 52a is displayed (or in which the region 52a is superimposed on the region 52b) and a state in which the region 52b is displayed (or in which the region 52b is superimposed on the region 52a) are switched at a predetermined frequency.

Further, when each inspection step is completed, a check is added in a square mark in front of the description of that inspection step included in the inspection procedure which is being displayed. However, instead of this, or in addition to this, the display form of the square mark in front of the description of that inspection step may be altered, and the display form of the description of that inspection step may be altered.

The above described alterations are not limited to the first operation example and may also be performed in other operation examples, including the operation examples described below.

### Second Operation Example

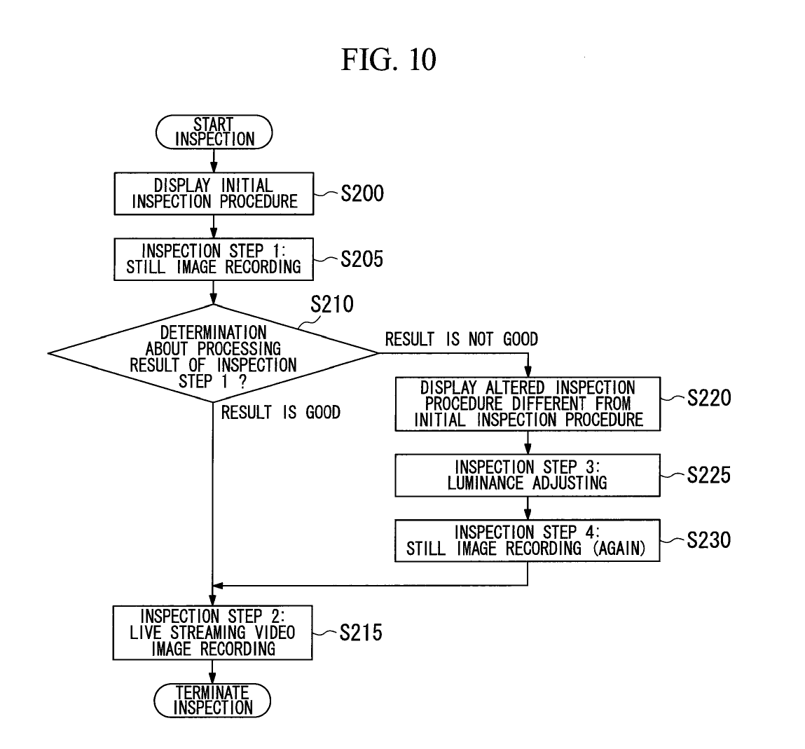

FIG. 10 shows the procedure of a second operation example. In the description given below, any description of the processing of an inspection step which is the same as in the first operation example is omitted.

(Steps S200 Through S205)

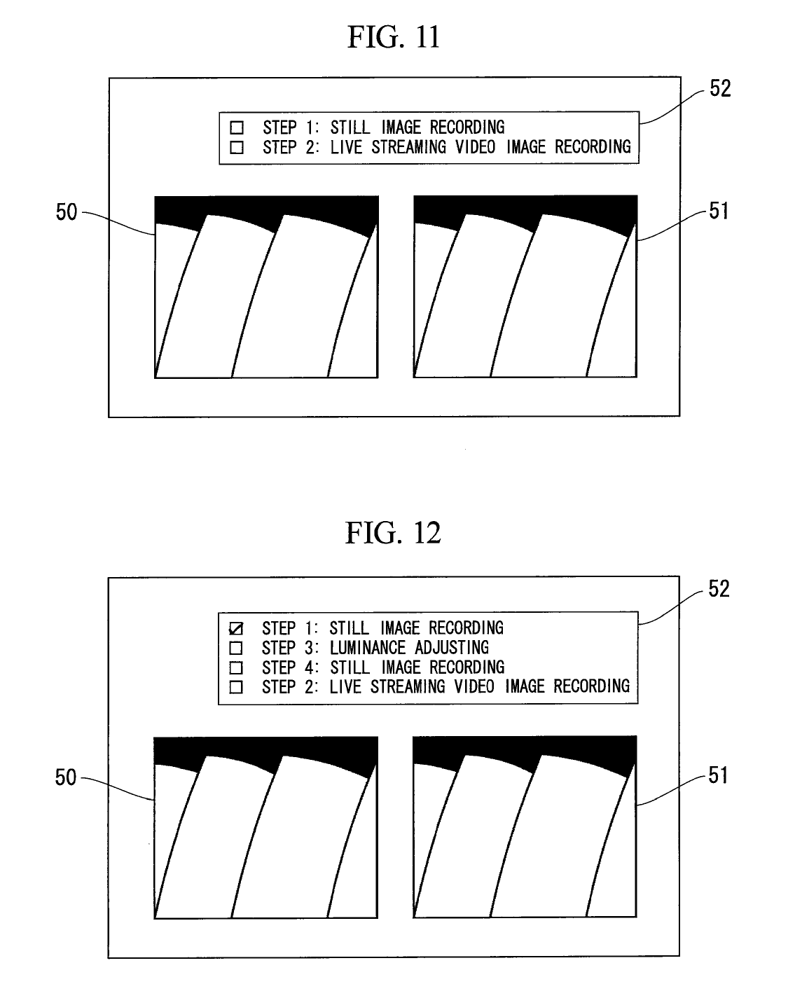

The processing of steps S200 through S205 is the same as the processing of steps S100 through S105 of FIG. 4. FIG. 11 shows the screen of the monitor 4 when the initial inspection procedure is displayed. The initial inspection procedure displayed in the region 52 includes two inspection steps, namely, still image recording and live streaming video image recording.

(Step S210)

When the still image data has been recorded in the memory card 32, a check is added in a square mark in front of the description of the still image recording included in the initial inspection procedure displayed on the monitor 4, by the control of the control section 44. Subsequently, the control section 44 makes a determination about (performs an evaluation of) the processing result of the still image recording. With this determination, the luminance of the still image which is one of the inspection conditions is determined (evaluated). More specifically, for example, the calculation section 42 calculates an average value of luminance of the entire image from luminance values of pixels in the still image data, and notifies the control section 44 of the average value. The control section 44 determines whether or not the average value is within a predetermined luminance range.

When the average value of luminance is within the predetermined luminance range, the control section 44 determines that the processing result is good (i.e., passes the evaluation). When the average value of luminance is out of the predetermined luminance range, the control section 44 determines that the processing result is not good (i.e., fails the evaluation).

(Step S215)

When the processing result is determined as good in step S210, the processing of the next inspection step, namely, of the live streaming video image recording is performed. The processing of the live streaming video image recording is the same as the processing of step S120 of FIG. 4. When the live streaming video image recording terminates, the inspection terminates.

(Step S220)

When the processing result is determined as not good in step S210, an altered inspection procedure which is different from the initial inspection procedure is displayed on the monitor 4. FIG. 12 shows the screen of the monitor 4 when the altered inspection procedure is displayed. The altered inspection procedure is displayed in the region 52 where the inspection procedure is displayed. The altered inspection procedure includes newly added two inspection steps, namely, luminance adjusting and still image recording, in addition to the two inspection steps of the still image recording and the live streaming video image recording which are included in the initial inspection procedure.

(Step S225)

After the altered inspection procedure is displayed, the processing of the newly added inspection step, namely, of the luminance adjusting is performed. In the luminance adjusting, the subject images captured by the imaging device 28 are updated at a constant frequency. In the luminance adjusting, when the average value of luminance of the entire image calculated in step S210 exceeds the predetermined luminance range, the control section 44 controls the light source driving device in the endoscope unit 8 so as to decrease the luminance. When the average value of luminance of the entire image calculated in step S210 is below the predetermined luminance range, the control section 44 controls the light source driving device in the endoscope unit 8 so as to increase the luminance. As a result, an inspection condition is altered.

(Step S230)

After the luminance adjusting has been performed, a check is added in a square mark in front of the description of the luminance adjusting included in the altered inspection procedure displayed on the monitor 4, by the control of the control section 44. Subsequently, the processing of the next inspection step, namely, of the still image recording is performed. In the still image recording, processing which is the same as the processing of step S205 is performed.

(Step S215)

When the still image data has been recorded in the memory card 32, a check is added in a square mark in front of the description of the still image recording included in the altered inspection procedure displayed on the monitor 4, by the control of the control section 44. Subsequently, the processing of the next inspection step, namely, of the live streaming video image recording is performed. The processing of the live streaming video image recording is as described above. When the live streaming video image recording terminates, the inspection terminates.

In the above-described example, when the processing result of the still image recording is determined as not good, it is possible to re-execute the still image recording before the live streaming video image recording is started. Therefore, it is possible to efficiently perform the inspection.

### Third Operation Example

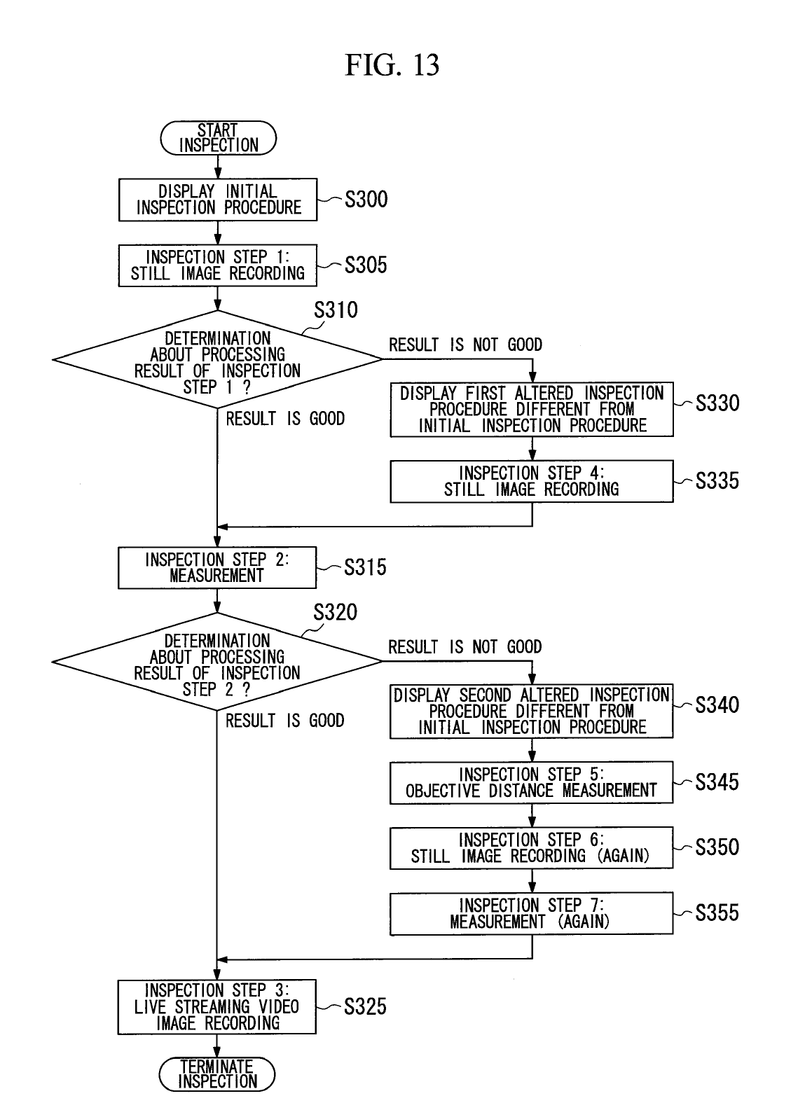

FIG. 13 shows the procedure of a third operation example. In the description given below, any description of the processing of an inspection step which is the same as in the first operation example or the second operation example is omitted.

(Steps S300 Through S305)

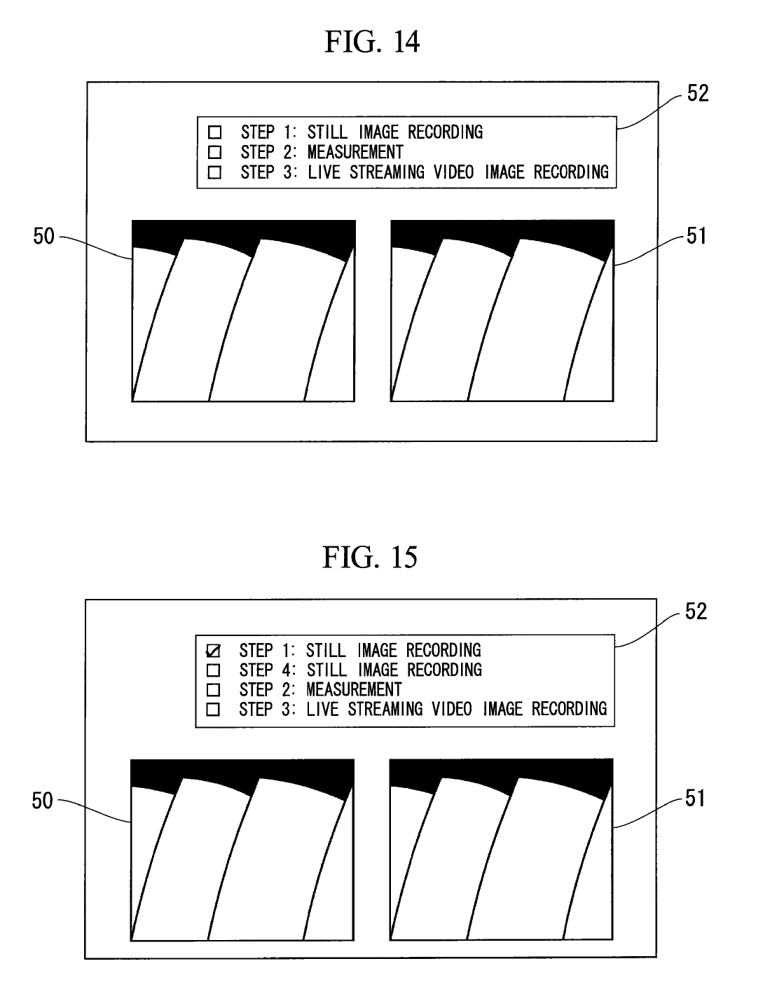

The processing of steps S300 through S305 is the same as the processing of steps S100 through S105 of FIG. 4. FIG. 14 shows the screen of the monitor 4 when the initial inspection procedure is displayed. The initial inspection procedure displayed in the region 52 includes three inspection steps, namely, still image recording, measurement, and live streaming video image recording.

(Step S310)

When the still image data has been recorded in the memory card 32, a check is added in a square mark in front of the description of the still image recording included in the initial inspection procedure displayed on the monitor 4, by the control of the control section 44. Subsequently, the control section 44 makes a determination about (performs an evaluation of) the processing result of the still image recording. In this determination (evaluation), the control section 44 determines whether or not an average value of luminance of the entire image is within a predetermined luminance range, in the same way as in step S210 of FIG. 10.

When the average value of luminance is within the predetermined luminance range, the control section 44 determines that the processing result is good (i.e., has passed the evaluation). When the average value of luminance is out of the predetermined luminance range, the control section 44 determines that the processing result is not good (i.e., has failed the evaluation).

(Step S315)

When the processing result is determined as good in step S310, the processing of the next inspection step, namely, of the measurement is performed. The processing of the measurement is the same as the processing of step S110 of FIG. 4.

(Step S320)

When the measurement result has been displayed on the monitor 4, a check is added in a square mark in front of the description of the measurement included in the initial inspection procedure displayed on the monitor 4, by the control of the control section 44. Subsequently, the control section 44 makes a determination about (performs an evaluation of) the processing result of the measurement. In this determination (evaluation), the determination is made using the contrast value of the texture, the object distance to the subject to be inspected, the normalized cross-correlation coefficient, or the like, in the same way as in step S115 of FIG. 4.

(Step S325)

When the processing result is determined as good (i.e., has passed the evaluation) in step S320, the processing of the next inspection step, namely, of the live streaming video image recording is performed. The processing of the live streaming video image recording is the same as the processing of step S120 of FIG. 4. When the live streaming video image recording terminates, the inspection also terminates.

(Step S330)

When the processing result is determined as not good (i.e., has failed the evaluation) in step S310, a first altered inspection procedure which is different from the initial inspection procedure is displayed on the monitor 4. FIG. 15 shows the screen of the monitor 4 when the first altered inspection procedure is displayed on the monitor 4. The first altered inspection procedure is displayed in the region 52. The first altered inspection procedure includes a newly added inspection step, namely, still image recording, in addition to the three inspection steps of the still image recording, the measurement, and the live streaming video image recording which are included in the initial inspection procedure.

(Step S335)

After the first altered inspection procedure is displayed, the processing of the newly added inspection step, namely, of the still image recording is performed. The processing of the still image recording is the same as the processing of step S305. In step S335, the still image is recorded at a timing different from the timing when the still image was recorded in step S305. Therefore, it is expected that a condition at the time of the still image recording is altered.

When the still image data has been recorded in the memory card 32, a check is added in a square mark in front of the description of the still image recording included in the first altered inspection procedure displayed on the monitor 4, by the control of the control section 44. Subsequently, step S315 (measurement) is performed, and then the determination of the processing result of the measurement is made in step S320.

(Step S340)

When the processing result is determined as not good in step S320, a second altered inspection procedure which is different from the initial inspection procedure and is also different from the first altered inspection procedure is displayed on the monitor 4. The second altered inspection procedure includes three newly added inspection steps, namely, objective distance measurement, still image recording, and measurement, in addition to the three inspection steps which are included in the initial inspection procedure or the four inspection steps which are included in the first altered inspection procedure.

(Step S345)

After the second altered inspection procedure is displayed, the processing of the first newly added inspection step, namely, of the objective distance measurement is performed. The processing of the objective distance measurement is the same as the processing of step S130 of FIG. 4. In the objective distance measurement, the inspector adjusts the position of the distal end portion 21 so that the objective distance becomes a distance suitable for measurement. As a result, an inspection condition is altered.

(Step S350)

After the objective distance is displayed, a check is added in a square mark in front of the description of the objective distance measurement included in the second altered inspection procedure displayed on the monitor 4, by the control of the control section 44. Subsequently, the processing of the next inspection step, namely, of the still image recording is performed. In the still image recording, processing which is the same as the processing of step S305 is performed.

(Step S355)

When the still image data has been recorded in the memory card 32, a check is added in a square mark in front of the description of the still image recording included in the second altered inspection procedure displayed on the monitor 4, by the control of the control section 44. Subsequently, the processing of the next inspection step, namely, of the measurement is performed. In the measurement, processing which is the same as the processing of step S315 is performed.

(Step S325)

When the measurement result has been displayed on the monitor 4, a check is added in a square mark in front of the description of the measurement included in the second altered inspection procedure displayed on the monitor 4, by the control of the control section 44. Subsequently, the processing of the next inspection step, namely, of the live streaming video image recording is performed. The processing of the live streaming video image recording is as described above. When the live streaming video image recording terminates, the inspection terminates.

In the above-described example, when the processing result of the still image recording is determined as not good or when the processing result of the measurement is determined as not good, it is possible to re-execute the still image recording or the measurement before the live streaming video image recording is started. Therefore, it is possible to efficiency perform the inspection.

In each of the first, second and third operation examples, various modifications in addition to those described above are also possible. For example, the inspection step of the live streaming video image recording may not be included in the initial inspection procedure and may be included in the altered inspection procedure. Further, stereo measurement is used in the inspection step of measurement, however, any type of measurement may be used as long as the measurement utilizes an image of the subject. Moreover, left and right subject images obtained via a stereo optical adaptor having two observation fields of view are displayed on the monitor 4, however, a subject image obtained via a normal observation optical adaptor having one observation field of view may be displayed on the monitor 4.

Further, the inspection is terminated after predetermined inspection steps included in the altered inspection procedure are performed, however, the inspection step may be repeated without terminating the inspection until a good processing result is obtained.

As is described above, according to the present embodiment, a determination is made about a condition when an inspection step is executed (Steps S115, S210, S310, and S320), and an altered inspection procedure is displayed in the case in which the condition fulfills a predetermined state (Steps S125, S220, S330, and S340) so that an inspection is performed in accordance with the altered inspection procedure. Therefore, since an appropriate inspection step to be performed next is selected based on the conditions at the time of inspection, it is possible to efficiently perform the inspection and it is possible to obtain more suitable inspection results.

Moreover, when an inspection procedure is displayed, by displaying inspection steps which have already been completed as distinct from uncompleted inspection steps, an inspector is able to ascertain the state of progress of an inspection.

Moreover, when displaying the altered inspection procedure, by displaying added inspection steps as distinct from the inspection steps included in the original inspection procedure, the inspector is able to easily ascertain the added inspection steps.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. An inspection apparatus comprising:
a display;
a first display control section which displays, on the display, instructions for carrying out a plurality of inspection steps with the inspection apparatus;
an evaluation section which performs an evaluation of a result of one of the inspection steps;
a second display control section which displays, on the display, additional instructions for carrying out at least one additional inspection step; and
a control section which controls the second display control section to display the additional instructions in response to the evaluation section determining that said one of the inspection steps has not passed the evaluation.

2. The apparatus according to claim 1, wherein the control section controls the evaluation section to perform the evaluation before completion of a final inspection step of the plurality of inspection steps.

3. The apparatus according to claim 1, wherein the control section controls the evaluation section to perform the evaluation immediately after said one of the inspection steps is performed.

4. The apparatus according to claim 1, wherein the control section controls the second display control section to display the additional instructions before completion of a final inspection step of the plurality of inspection steps.

5. The apparatus according to claim 1, wherein the at least one additional inspection step comprises an inspection step to be performed before completion of a final inspection step of the plurality of inspection steps.

6. A method for an inspection apparatus including a display, the method comprising:
displaying, on the display, instructions for carrying out a plurality of inspection steps with the inspection apparatus;
performing an evaluation on a result of one of the inspection steps; and
displaying, on the display, additional instructions for carrying out at least one additional inspection step in response a determination that said one of the inspection steps has not passed the evaluation.

7. The method according to claim 6, wherein the evaluation is performed before completion of a final inspection step of the plurality of inspection steps.

8. The method according to claim 6, wherein the evaluation is performed immediately after said one of the inspection steps is performed.

9. The method according to claim 6, wherein the additional instructions are displayed on the display before completion of a final inspection step of the plurality of inspection steps.

10. The method according to claim 6, wherein the at least one additional inspection step comprises an inspection step to be performed before completion of a final inspection step of the plurality of inspection steps.

11. An inspection apparatus comprising:
a display;
first display control means for displaying, on the display, instructions for carrying out a plurality of inspection steps with the inspection apparatus;
evaluating means for performing an evaluation of a result of one of the inspection steps;
second display control means for displaying, on the display, additional instructions for carrying out at least one additional inspection step; and
control means for controlling the second display control means to display the additional instructions in response to the evaluating means determining that said one of the inspection steps has not passed the evaluation.

12. The apparatus according to claim 11, wherein the control means controls the evaluating means to perform the evaluation before completion of a final inspection step of the plurality of inspection steps.

13. The apparatus according to claim 11, wherein the control means controls the evaluating means to perform the evaluation immediately after said one of the inspection steps is performed.

14. The apparatus according to claim 11, wherein the control means controls the second display control means to display the additional instructions before completion of a final inspection step of the plurality of inspection steps.

15. The apparatus according to claim 11, wherein the at least one additional inspection step comprises an inspection step to be performed before completion of a final inspection step of the plurality of inspection steps.

16. A non-transitory computer readable recording medium having a computer program stored thereon that is executable by a computer of an inspection apparatus including a display, to control the inspection apparatus to perform functions comprising:
displaying, on the display, instructions for carrying out a plurality of inspection steps with the inspection apparatus;
performing an evaluation on a result of one of the inspection steps; and
displaying, on the display, additional instructions for carrying out at least one additional inspection step in response a determination that said one of the inspection steps has not passed the evaluation.

17. The non-transitory computer readable recording medium according to claim 16, wherein the program is executable by the computer to control the inspection apparatus to perform the evaluation before completion of a final inspection step of the plurality of inspection steps.
